(19) United States
(12) Patent Application Publication
(10) Pub. No.: US 2026/0343291 A1
(43) Pub. Date: Oct. 29, 2026

(54) METHOD FOR REPORTING A TERMINAL CAPABILITY, NETWORK DEVICE, TERMINAL AND STORAGE MEDIUM

(71) Applicant: Beijing Xiaomi Mobile Software Co., Ltd., Beijing (CN)

(72) Inventors: Rui ZHOU, Beijing (CN); Xuhua TAO, Beijing (CN)

(21) Appl. No.: 19/124,204

(22) PCT Filed: Oct. 25, 2022
(86) PCT No.: PCT/CN2022/127490

§ 371 Date: Apr. 24, 2025

(51) Int. Cl. H04W 24/10; H04W 64/00

(52) U.S. Cl. CPC H04W 24/10; H04W 64/00

(57) ABSTRACT

A method for reporting a terminal capability, performed by a network device, including: receiving capability information reported by a terminal, where the capability information is configured to indicate whether the terminal supports performing layer 1 measurement and layer 3 measurement simultaneously.

### CROSS-REFERENCE TO RELATED APPLICATION

The present application is a U.S. National Stage of International Application No. PCT/CN2022/127490, filed on Oct. 25, 2022, the contents of all of which are incorporated herein by reference in their entirety for all purposes.

### BACKGROUND OF THE INVENTION

In the related art, at a resource position where layer 1 measurement and layer 3 measurement overlap, a terminal is unable to perform the layer 1 measurement and the layer 3 measurement simultaneously. Instead, the terminal performs the layer 1 measurement only after the layer 3 measurement is completed.

### SUMMARY OF THE INVENTION

The present disclosure relates to the technical field of communication, and in particular to a method for reporting a terminal capability, network device, terminal and storage medium.

In a first aspect, the examples of the present disclosure provide a method for reporting a terminal capability. The method is performed by a network device. The method includes: receiving capability information reported by a terminal, where the capability information is configured to indicate whether the terminal supports performing layer 1 measurement and layer 3 measurement simultaneously.

In a second aspect, the examples of the present disclosure provide another method for reporting a terminal capability. The method is performed by a terminal. The method includes: reporting capability information to a network device, where the capability information is configured to indicate whether the terminal supports performing layer 1 measurement and layer 3 measurement simultaneously.

In a third aspect, the examples of the present disclosure provide a communication device. The communication device has some or all of functions of the network device in the method of the first aspect. For example, the communication device may have some or all of the functions in the examples of the present disclosure, or may have the functions of implementing any one of the examples of the present disclosure alone. The functions may be implemented through hardware, or by executing corresponding software by hardware. The hardware or software includes one or more units or modules corresponding to the functions.

In a fourth aspect, the examples of the present disclosure provide another communication device. The communication device has some or all of functions of a terminal in the method of the second aspect. For example, the communication device may have some or all of the functions in the examples of the present disclosure, or may have the functions of implementing any one of the examples of the present disclosure alone. The functions may be implemented through hardware, or by executing corresponding software by hardware. The hardware or software includes one or more units or modules corresponding to the functions.

In a fifth aspect, the examples of the present disclosure provide a communication device. The communication device includes one or more processors. The one or more processors, when calling a computer program stored in a memory, perform the method of the first aspect.

In a sixth aspect, the examples of the present disclosure provide a communication device. The communication device includes one or more processors. The one or more processors, when calling a computer program stored in a memory, perform the method of the second aspect.

In a seventh aspect, the examples of the present disclosure provide a communication device. The communication device includes one or more processors and a memory. The memory stores a computer program. The one or more processors execute the computer program stored in the memory to cause the communication device to perform the method of the first aspect.

In an eighth aspect, the examples of the present disclosure provide a communication device. The communication device includes one or more processors and a memory. The memory stores a computer program. The one or more processors execute the computer program stored in the memory to cause the communication device to perform the method of the second aspect.

In a ninth aspect, the examples of the present disclosure provide a communication device. The communication device includes one or more processors and an interface circuit. The interface circuit is configured to receive code instructions and transmit the code instructions to the one or more processors. The one or more processors are collectively configured to run the code instructions to cause the communication device to perform the method of the first aspect.

In a tenth aspect, the examples of the present disclosure provide a communication device. The communication device includes one or more processors and an interface circuit. The interface circuit is configured to receive code instructions and transmit the code instructions to the one or more processors. The one or more processors are collectively configured to run the code instructions to cause the communication device to perform the method of the second aspect.

In an eleventh aspect, the examples of the present disclosure provide a system for reporting a terminal capability. The system includes the communication device of the third aspect and the communication device of the fourth aspect. Alternatively, the system includes the communication device of the fifth aspect and the communication device of the sixth aspect. Alternatively, the system includes the communication device of the seventh aspect and the communication device of the eighth aspect. Alternatively, the system includes the communication device of the ninth aspect and the communication device of the tenth aspect.

In a twelfth aspect, the examples of the present disclosure provide a non-transitory computer-readable storage medium. The non-transitory computer-readable storage medium is configured to store instructions for a network device described above. When the instructions are executed, the network device is caused to perform the method of the first aspect.

In a thirteenth aspect, the examples of the present disclosure provide a non-transitory computer-readable storage medium. The non-transitory computer-readable storage medium is configured to store instructions for the terminal described above. When the instructions are executed, the terminal is caused to perform the method of the second aspect.

In a fourteenth aspect, the present disclosure further provides a computer program product including a computer program. When run on a computer, the computer program product causes the computer to perform the method of the first aspect.

In a fifteenth aspect, the present disclosure further provides a computer program product including a computer program. When run on a computer, the computer program product causes the computer to perform the method of the second aspect.

In a sixteenth aspect, the present disclosure provides a chip system. The chip system includes at least one processor and an interface, the chip system is configured to support the network device in implementing functions in the first aspect, for example, determining or processing at least one of data and information according to the method above.

In a seventeenth aspect, the present disclosure provides a chip system. The chip system includes at least one processor and an interface, the chip system is configured to support the terminal in implementing functions in the second aspect, for example, determining or processing at least one of data and information according to the method above.

In an eighteenth aspect, the present disclosure provides a computer program. When run on a computer, the computer program causes the computer to perform the method of the first aspect.

In a nineteenth aspect, the present disclosure provides a computer program. When run on a computer, the computer program causes the computer to perform the method of the second aspect.

### BRIEF DESCRIPTION OF DRAWINGS

In order to more clearly illustrate examples of the present disclosure or the technical solution in the related art, the accompanying drawings required for the examples of the present disclosure or the related art will be explained.

FIG. 1 is an architecture diagram of a communication system according to an example of the present disclosure.

FIG. 2 is a schematic diagram of 8-beam scanning of a terminal according to an example of the present disclosure.

FIG. 3 is a flowchart of a method for reporting a terminal capability according to an example of the present disclosure.

FIG. 4 is a flowchart of a method for configuring measurement according to an example of the present disclosure.

FIG. 5 is a flowchart of another method for configuring measurement according to an example of the present disclosure.

FIG. 6 is a flowchart of yet another method for configuring measurement according to an example of the present disclosure.

FIG. 7 is a structural diagram of a communication device according to an example of the present disclosure.

FIG. 8 is a structural diagram of another communication device according to an example of the present disclosure.

FIG. 9 is a schematic structural diagram of a chip according to an example of the present disclosure.

### DETAILED DESCRIPTION OF THE INVENTION

In order to better understand a method for reporting a terminal capability, network device, terminal and storage medium disclosed in examples of the present disclosure, a communication system to which the examples of the present disclosure are applicable is first described.

Description will be made in detail to examples, and their instances are illustrated in the accompanying drawings. When the following description relates to the accompanying drawings, the same numbers in different accompanying drawings denote the same or similar elements, unless indicated otherwise. The implementations described in the following examples do not represent all implementations consistent with the present disclosure. Rather, they are merely instances of devices and methods consistent with some aspects of the present disclosure as detailed in the appended claims.

The terms used in the present disclosure are merely to describe the specific examples, instead of limiting the present disclosure. The singular forms such as “a”, “an”, “the”, and “this” used in the present disclosure and the appended claims are also intended to include the plural forms unless clearly stated otherwise in the context. It should also be understood that the term “and/or” used refers to and encompasses any or all possible combinations of one or more of associated items listed.

It is to be understood that although the terms “first”, “second”, “third”, etc. may be employed in the present disclosure to describe various information, such information should not be limited to these terms. These terms are merely used to distinguish the same type of information from each other. For example, first information can also be referred to as second information, and similarly, second information can also be referred to as first information, without departing from the scope of the present disclosure. Depending on the context, the word “in a case where” as used can be interpreted as “at the time of”, “when”, or “in response to determining”.

It is to be noted that information (including but not limited to user equipment information, user personal information, etc.), data (including but not limited to data for analysis, stored data, displayed data, etc.) and signals involved in the present disclosure are authorized by users or fully authorized by all parties. Collection, use and processing of relevant data need to comply with relevant laws, regulations and standards of relevant countries and regions.

With reference to FIG. 1, FIG. 1 is a schematic diagram of an architecture of a communication system according to an example of the present disclosure. The communication system may include, but is not limited to, one network device and one terminal. The number and form of devices shown in FIG. 1 are only illustrative and do not constitute a limitation to the example of the present disclosure. The communication system may include two or more network devices and two or more terminals in an actual application. For example, the communication system 10 shown in FIG. 1 includes one network device 101 and one terminal 102.

It is to be noted that the technical solution of the example of the present disclosure may be applied to various communication systems, for example, a long term evolution (LTE) system, a 5th generation (5G) mobile communication system, a 5G new radio (NR) system, and other future new mobile communication system, etc.

The network device 101 in the example of the present disclosure is an entity on a network side for transmitting or receiving signals. For example, the network device 101 may be an evolved NodeB (eNB), a transmission reception point (TRP), a next generation NodeB (gNBs) in an NR system, a network device in other future mobile communication systems, and an access node in a wireless fidelity (WiFi) system, etc. The example of the present disclosure does not limit a particular technology and a particular device form used by the network device. The network device provided in the example of the present disclosure may be composed of a central unit (CU) and a distributed unit (DU). The CU may also be referred to as a control unit. By using a CU-DU structure, a network device, such as protocol layers of the network device, may be split, functions of some protocol layers are centrally controlled by the CU, functions of some or all of the remaining protocol layers are distributed in the DU, and the DU is centrally controlled by the CU.

The terminal 102 in the example of the present disclosure is an entity on a user side configured to receive or transmit signals, such as a mobile phone. The terminal may also be referred to as a terminal, user equipment (UE), a mobile station (MS), a mobile device (MT), etc. The terminal may be a car with a communication function, a smart car, a mobile phone, a wearable device, a Pad, a computer with a radio transceiving function, a virtual reality (VR) terminal, an augmented reality (AR) terminal, a radio terminal in industrial control, a radio terminal in self-driving, a radio terminal in remote medical surgery, a radio terminal in a smart grid, a radio terminal in transportation safety, a radio terminal in a smart city, a radio terminal in smart home, etc. The example of the present disclosure does not limit a particular technology and a particular device form used by the terminal.

It is to be understood that the communication system described in the examples of the present disclosure is for the purpose of more clearly illustrating the technical solutions provided in the examples of the present disclosure, and does not constitute a limitation on the technical solutions provided in the examples of the present disclosure. Those skilled in the art will know that the technical solutions provided in the examples of the present disclosure are also applicable to similar technical problems along with evolution of a system architecture and emergence of new service scenes.

Moreover, in order to facilitate understanding of the examples of the present disclosure, the following explanations are made.

First, in the examples of the present disclosure, “configured to indicate” may include “configured to directly indicate” and “configured to indirectly indicate”. In describing a case where information is configured to indicate A, it may include that the information directly indicates A or indirectly indicates A, and does not necessarily mean that A is carried in the information certainly. For example, other messages that may determine A may be carried in the information.

Information indicated by the information is referred to as to-be-indicated information. In a specific implementation process, there are many ways to indicate the to-be-indicated information. For example, but not limited to, the to-be-indicated information may be directly indicated, such as the to-be-indicated information itself or an index of the to-be-indicated information. The to-be-indicated information may also be indirectly indicated by indicating other information, there is an association relationship between the other information and the to-be-indicated information. It is also to indicate only a part of the to-be-indicated information, while other parts of the to-be-indicated information are known or agreed upon in advance. For example, specific information may also be indicated through a pre-agreed (for example, protocol specified) arrangement order of the individual pieces of information, thus reducing the indication overhead to some extent.

The to-be-indicated information may be transmitted together as a whole, or may be divided into a plurality of pieces of sub-information to be transmitted separately, and at least one of transmitting periods or transmitting time of the sub-information may be the same or not. A specific transmitting method is not limited in the present disclosure. At least one of the transmitting periods or the transmitting time of the sub-information may be predefined, for example, predefined according to a protocol.

Second, numerical numbers such as first and second in the present disclosure are merely for distinction for convenience of description, and are not intended to limit the scope of the examples of the present disclosure. For example, the numerical numbers are configured to distinguish between different information.

Third, the “protocol” involved in the examples of the present disclosure may refer to a standard protocol in a communication field, for example, may include an LTE protocol, an NR protocol, and related protocols applied to a future communication system, which is not limited in the present disclosure.

Fourth, the examples of the present disclosure enumerate a plurality of implementations to clearly describe the technical solutions of the examples of the present disclosure. Certainly, those skilled in the art may understand that the plurality of examples provided in the examples of the present disclosure may be implemented independently, may be implemented along with the methods of other examples in the examples of the present disclosure, or may be implemented along with some methods of other related arts independently or in combination, which are not limited in the examples of the present disclosure.

In the related art, a 5G frequency range is defined according to a 3rd generation partnership project (3GPP), and is divided into frequency range (FR) 1 (450 MHz-6000 MHz, also referred to as Sub-6 GHz) and FR2 (24250 MHz-52600 MHz, also referred to as Above-6 GHz or millimeter wave).

In an FR2 millimeter wave band, the terminal adopts a beamforming method, so during reception operations, the terminal no longer needs to additionally introduce beamforming management of receiving beams like in a case of using omnidirectional antennas in an FR1 low band. Instead, the terminal adopts a best receiving beam for receiving, so as to achieve a larger uplink coverage range and a better transmission rate. Meanwhile, due to introduction of a beam concept, spatial dimension is further introduced into transmission of the terminal. That is, physical resources at same time and frequency may be further multiplexed through different beams. The terminal may adopt a receiving beam scanning manner at a receiving end to achieve better coverage of a receiving angle.

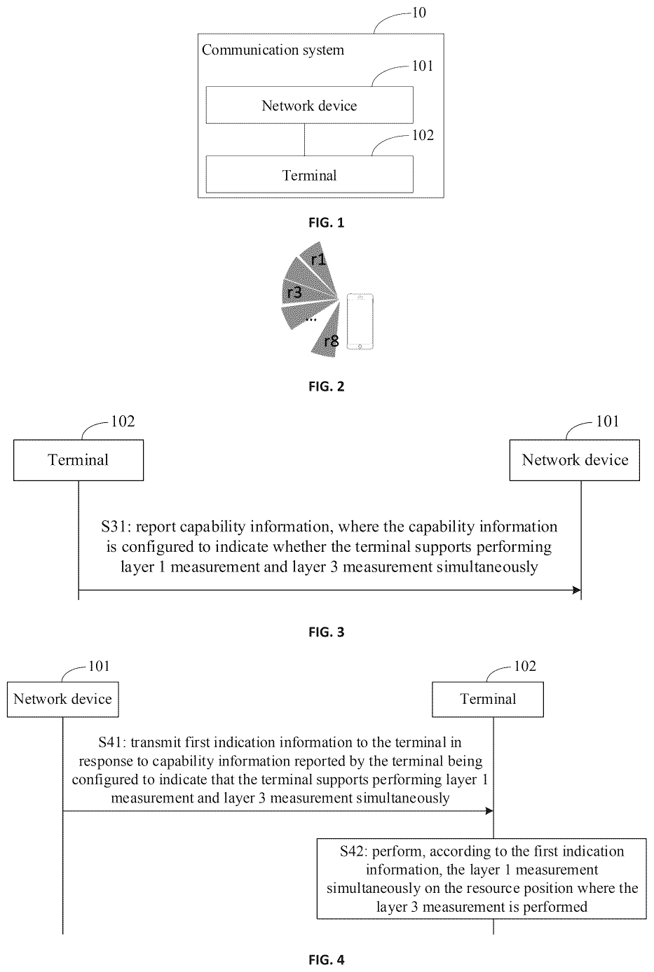

In the related art, as shown in FIG. 2, in synchronization signal block (SSB) measurement of FR2, the terminal may adopt a method that 8 receiving beams cover a range of 120°. This method is a conclusion reached by comprehensively considering factors such as implementation complexity, coverage angle, hardware cost, etc.

However, this introduces a new problem, that is, at a same moment, an analog shaped beam may only generate one beam in one direction, and the terminal may only use one single beam to perform measurement during measurement. In a case where the terminal performs measurement, for measurement of layer 1 (L1), a fine beam consistent with actual data transmission is used, in order to switch beams more flexibly. For measurement of layer 3 (L3), a coarse beam is often used to reduce measurement time of mobility management. Because of inconsistency of beams, a terminal of FR2 cannot complete the L1 measurement and the L3 measurement simultaneously at the same moment. Accordingly, it is required that on an SSB measurement symbol configured for the L3 measurement in an SSB measurement configuration (SSB-To Measure), in a case where a measurement reference signal of the L1 measurement overlap the SSB measurement symbol configured for the L3 measurement in time domain or one consecutive data symbol of the SSB measurement symbol, the terminal needs to perform the L3 measurement on these symbols, and L1 related measurement cannot be completed. This results in the L1 measurement being forced to delay, and the time for the L1 measurement is greatly increased, which is contrary to an initial expectation of more flexible beam switching.

In the related art, it has been proposed that the terminal may perform the layer 1 measurement and the layer 3 measurement simultaneously. However, it does not support the terminal in reporting capability information to a network device, where the capability information indicates whether the terminal supports performing the layer 1 measurement and the layer 3 measurement simultaneously. This is an urgent problem that needs to be solved.

In order to overcome this difficulty, in the example of the present disclosure, the terminal may perform the L1 measurement and the L3 measurement simultaneously by adding analog shaped beams, or by increasing a hardware capability such as adding receiving links, such that faster L1 measurement and optimization of beam management can be achieved. Moreover, in the example of the present disclosure, the terminal is further supported to report, to the network device, the capability information configured to indicate whether the terminal supports performing the layer 1 measurement and the layer 3 measurement simultaneously.

The method for reporting a terminal capability, network device, terminal and storage medium provided in the present disclosure are described in detail in conjunction with the accompanying drawings.

With reference to FIG. 3, FIG. 3 is a flowchart of a method for reporting a terminal capability according to an example of the present disclosure.

As shown in FIG. 3, the method may include, but is not limited to S31.

In S31, a terminal 102 reports capability information to a network device 101, where the capability information is configured to indicate whether the terminal supports performing layer 1 measurement and layer 3 measurement simultaneously.

In the example of the present disclosure, the terminal may support performing the layer 1 (L1) measurement and the layer 3 (L3) measurement simultaneously by adding analog shaped beams, or by increasing a hardware capability such as adding receiving links.

In view of this, the terminal may report the capability information to the network device. The capability information is configured to indicate whether the terminal supports performing layer 1 measurement and layer 3 measurement simultaneously.

In the example of the present disclosure, the capability information is configured to indicate whether the terminal supports performing the layer 1 measurement and the layer 3 measurement simultaneously. The capability information may indicate that the terminal supports performing the layer 1 measurement and the layer 3 measurement simultaneously, and the capability information may further indicate that the terminal does not support performing the layer 1 measurement and the layer 3 measurement simultaneously.

In some implementations, by a protocol agreement, in a case that the capability information indicates that the terminal supports performing the layer 1 measurement and the layer 3 measurement simultaneously, in a case of the terminal reporting the capability information to the network device, the network device may determine that the terminal supports performing the layer 1 measurement and the layer 3 measurement simultaneously. On the contrary, in a case of the terminal not reporting the capability information to the network device, the network device may determine that the terminal does not support performing the layer 1 measurement and the layer 3 measurement simultaneously.

In some implementations, by a protocol agreement, in a case that the capability information indicates that the terminal does not support performing the layer 1 measurement and the layer 3 measurement simultaneously, in a case of the terminal reporting the capability information to the network device, the network device may determine that the terminal does not support performing the layer 1 measurement and the layer 3 measurement simultaneously. On the contrary, in a case of the terminal not reporting the capability information to the network device, the network device may determine that the terminal supports performing the layer 1 measurement and the layer 3 measurement simultaneously.

It may be understood that in a case that the terminal has a capability of performing the layer 1 measurement and layer 3 measurement simultaneously, the capability information indicating whether the terminal supports performing the layer 1 measurement and the layer 3 measurement simultaneously may be reported to the network device. In a case that the terminal does not have the capability of performing the layer 1 measurement and the layer 3 measurement simultaneously, the capability information indicating whether the terminal supports performing the layer 1 measurement and the layer 3 measurement simultaneously may also be reported to the network device.

In the example of the present disclosure, the terminal may report the capability information to the network device based on an implementation, the terminal may report the capability information to the network device based on a configuration of the network device, or the terminal may report the capability information to the network device based on a protocol agreement. This is not limited in the example of the present disclosure.

In some examples, the capability information is one bit. The one bit being a first value indicates that the terminal supports performing the layer 1 measurement and the layer 3 measurement simultaneously. The one bit being a second value indicates that the terminal does not support performing the layer 1 measurement and the layer 3 measurement simultaneously.

In the example of the present disclosure, the terminal reports the capability information to the network device. The terminal may report one bit to the network device. The one bit being a first value indicates that the terminal supports performing the layer 1 measurement and the layer 3 measurement simultaneously. The one bit being a second value indicates that the terminal does not support performing the layer 1 measurement and the layer 3 measurement simultaneously.

The first value may be 1, and the second value may be 0. Alternatively, the first value may be 0, and the second value may be 1, etc.

In the example of the present disclosure, the terminal may report the capability information to the network device through radio resource control (RRC) signaling.

It may be understood that after receiving the capability information reported by the terminal, the network device may perform a measurement configuration on the terminal according to the capability information reported by the terminal.

In some implementations, the capability information reported by the terminal to the network device indicates that the terminal supports performing the layer 1 measurement and the layer 3 measurement simultaneously. The network device may transmit first indication information to the terminal, to indicate that the terminal performs the layer 1 measurement on a resource position where the layer 3 measurement is performed.

The network device may transmit, to the terminal, a resource position where the layer 1 measurement and the layer 3 measurement are performed simultaneously. Alternatively, the network device may further indicate, to the terminal, a resource position where the layer 1 measurement is performed and a resource position where the layer 3 measurement is performed, respectively. The resource position where the layer 1 measurement is performed and the resource position where the layer 3 measurement is performed have an overlapping portion. The overlapping portion has a resource position where the terminal may perform the layer 1 measurement and the layer 3 measurement simultaneously.

Illustratively, the network device may transmit a measurement configuration to the terminal. The measurement configuration indicates a resource position, for example, a symbol position of an SSB, for the terminal to perform the layer 3 measurement. The network device may also transmit RRC signaling to the terminal to transmit the symbol location to the terminal.

Accordingly, after receiving the first indication information transmitted by the network device, the terminal may perform the layer 1 measurement simultaneously on the resource position where the layer 3 measurement is performed. The resource position is indicated by the first indication information transmitted by the network device.

In some examples, the network device transmits a measurement configuration to the terminal. The measurement configuration is configured to indicate the resource position for the terminal to perform the layer 3 measurement.

In the example of the present disclosure, the terminal may further receive the measurement configuration transmitted by the network device. In a case that the measurement configuration is configured to indicate that the terminal performs the layer 3 measurement, the resource position where the layer 3 measurement is performed is determined according to the measurement configuration.

The network device transmits the measurement configuration to the terminal. The network device may transmit an SSB measurement configuration to the terminal. The SSB measurement configuration is configured to indicate the resource position for the terminal to perform the layer 3 measurement.

In some implementations, the capability information reported by the terminal to the network device indicates that the terminal does not support performing the layer 1 measurement and the layer 3 measurement simultaneously. The network device may transmit measurement configuration information to the terminal, to indicate, to the terminal, a resource position where the layer 1 measurement is performed and a resource position where the layer 3 measurement is performed, respectively. There is no overlap in the resource position where the layer 1 measurement is performed and the resource position where the layer 3 measurement is performed indicated by the measurement configuration information transmitted by the network device.

Accordingly, after receiving the measurement configuration information transmitted by the network device, the terminal may perform the layer 1 measurement and the layer 3 measurement on the resource position where the layer 1 measurement is performed and the resource location where the layer 3 measurement is performed, respectively, indicated by the measurement configuration information transmitted by the network device.

It may be understood that, after completing the layer 1 measurement, the terminal may report a measurement result to the network device. The network device may perform corresponding beam management according to the measurement result reported by the terminal.

Illustratively, the measurement result reported by the terminal after completing the layer 1 measurement may be a measurement result of layer 1 reference signal received power (L1-RSRP) or a measurement result of layer 1 signal interference noise ratio (L1-SINR).

Through the example of the present disclosure, the terminal reports the capability information to the network device. The capability information is configured to indicate whether the terminal supports performing the layer 1 measurement and the layer 3 measurement simultaneously. Thus, the terminal may be supported to report, to the network device, the capability information configured to indicate whether the terminal supports performing the layer 1 measurement and the layer 3 measurement simultaneously.

With reference to FIG. 4, FIG. 4 is a flowchart of a method for configuring measurement according to an example of the present disclosure. As shown in FIG. 4, the method may include, but is not limited to S41 to S42.

In S41, a network device 101 transmits first indication information to a terminal 102 in response to the capability information reported by the terminal 102 being configured to indicate that the terminal 102 supports performing layer 1 measurement and layer 3 measurement simultaneously. The first indication information is configured to indicate that the terminal 102 performs the layer 1 measurement on a resource position where the layer 3 measurement is performed.

Reference may be made to relevant description in the examples for relevant description about that the network device receives the capability information reported by the terminal, which is not repeated.

Reference may be made to relevant description in the examples for relevant description of the capability information, which is not repeated.

In the example of the present disclosure, the network device may transmit the first indication information to the terminal, in a case that the capability information reported by the terminal is configured to indicate that the terminal supports performing the layer 1 measurement and the layer 3 measurement simultaneously. The first indication information is configured to indicate that the terminal performs the layer 1 measurement on a resource position where the layer 3 measurement is performed.

The network device transmits the first indication information to the terminal. The network device may transmit RRC signaling to the terminal. The RRC signaling is configured to indicate that the terminal performs the layer 1 measurement on the resource position where the layer 3 measurement is performed.

In the example of the present disclosure, the resource position for the terminal to perform the layer 3 measurement may be the symbol position of the SSB.

In S42, the terminal 102 performs, according to the first indication information, the layer 1 measurement simultaneously on the resource position where the layer 3 measurement is performed.

In the example of the present disclosure, after receiving the first indication information transmitted by the network device, the terminal may perform the layer 1 measurement simultaneously on the resource position where the layer 3 measurement is performed.

Reference may be made to the relevant description that the network device transmits the measurement configuration to the terminal in the example for a method for determining the resource position for the layer 3 measurement by the terminal, which is not repeated.

It is to be noted that in the example of the present disclosure, S41 to S42 may be implemented independently, or may be implemented together with any other step in the example of the present disclosure, for example, implemented together with S31 in the example of the present disclosure, which is not limited in the example of the present disclosure.

By implementing the example of the present disclosure, the network device transmits the first indication information to the terminal, in response to the capability information reported by the terminal being configured to indicate that the terminal supports performing the layer 1 measurement and the layer 3 measurement simultaneously. The first indication information is configured to indicate that the terminal performs the layer 1 measurement on the resource position where the layer 3 measurement is performed. The terminal performs, according to the first indication information, the layer 1 measurement simultaneously on the resource position where the layer 3 measurement is performed. Accordingly, the network device may configure, according to the capability information reported by the terminal, the resource position for the terminal to perform the layer 1 measurement and the layer 3 measurement simultaneously. The terminal may perform the layer 1 measurement and the layer 3 measurement simultaneously on the resource position indicated by the network device.

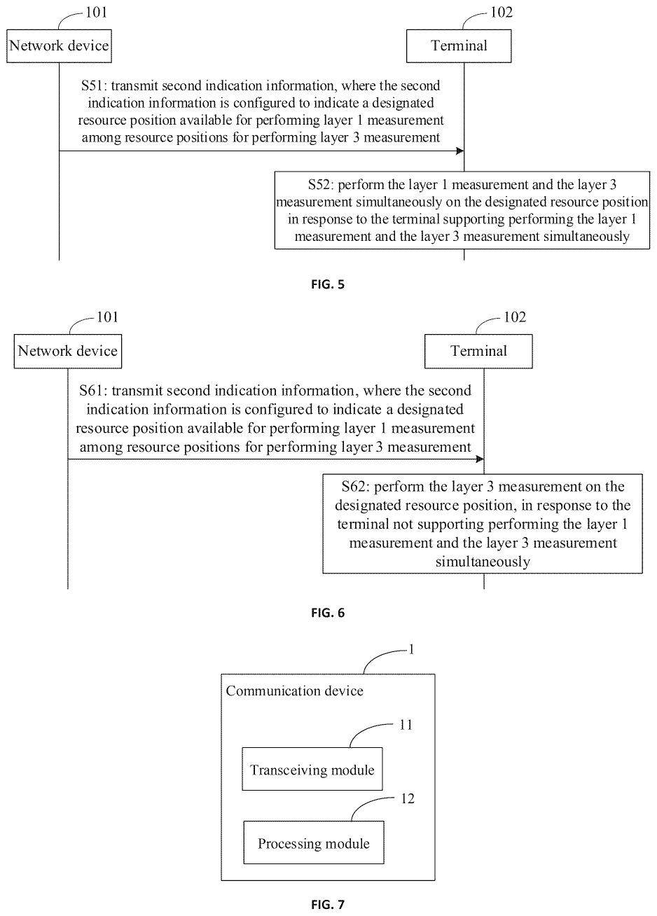

With reference to FIG. 5, FIG. 5 is a flowchart of another method for configuring measurement according to an example of the present disclosure. As shown in FIG. 5, the method may include, but is not limited to S51 to S52.

In S51, a network device 101 transmits second indication information to a terminal 102. The second indication information is configured to indicate a designated resource position available for performing layer 1 measurement among resource positions for performing layer 3 measurement.

In the example of the present disclosure, the network device may transmit the second indication information to the terminal. The second indication information is configured to indicate the designated resource position available for performing the layer 1 measurement among the resource positions for performing the layer 3 measurement.

It may be understood that the designated resource positions may be some or all of the resource positions for the terminal to perform the layer 3 measurement.

The second indication information indicates the designated resource position available for performing the layer 1 measurement among the resource position where the layer 3 measurement is performed. The terminal may determine that the layer 1 measurement and the layer 3 measurement may be performed on the designated resource position simultaneously.

The network device transmits the second indication information to the terminal. The network device may transmit RRC signaling to the terminal. The RRC signaling is configured to indicate the designated resource position available for performing the layer 1 measurement among the resource positions where the layer 3 measurement is performed.

Reference may be made to the relevant description that the network device transmits the measurement configuration to the terminal in the example for a method for determining the resource position for performing the layer 3 measurement by the terminal, which is not repeated.

In S52, a terminal 102 performs the layer 1 measurement and the layer 3 measurement simultaneously on the designated resource position, in response to the terminal 102 supporting performing the layer 1 measurement and the layer 3 measurement simultaneously.

In the example of the present disclosure, the terminal receives the second indication information transmitted by the network device. The second indication information indicates the designated resource position available for performing the layer 1 measurement among the resource position where the layer 3 measurement is performed. The terminal may determine that the layer 1 measurement and the layer 3 measurement may be simultaneously performed on the designated resource position.

However, the terminal needs to determine whether the terminal supports performing the layer 1 measurement and the layer 3 measurement. The layer 1 measurement and the layer 3 measurement may be performed simultaneously on the designated resource position in a case that the terminal supports performing the layer 1 measurement and the layer 3 measurement simultaneously.

It is to be noted that in the example of the present disclosure, S51 to S52 may be implemented independently, or may be implemented together with any another step in the example of the present disclosure, for example, implemented together with S31 in the example of the present disclosure, which is not limited in the example of the present disclosure.

By implementing the example of the present disclosure, the network device transmits the second indication information to the terminal. The second indication information is configured to indicate the designated resource position available for performing the layer 1 measurement among the resource position where the layer 3 measurement is performed. The terminal performs the layer 1 measurement and the layer 3 measurement simultaneously on the designated resource position, in response to the terminal supporting performing the layer 1 measurement and the layer 3 measurement simultaneously. Thus, in a case of supporting performing the layer 1 measurement and the layer 3 measurement simultaneously, the terminal may perform the layer 1 measurement and the layer 3 measurement simultaneously on the designated resource position indicated by the network device.

With reference to FIG. 6, FIG. 6 is a flowchart of yet another method for configuring measurement according to an example of the present disclosure. As shown in FIG. 6, the method may include, but is not limited to S61 to S62.

In S61, a network device 101 transmits second indication information to a terminal 102. The second indication information is configured to indicate a designated resource position available for performing layer 1 measurement among resource positions where the layer 3 measurement is performed.

Reference may be made to relevant description in the examples for relevant description of S61, which is not repeated.

In S62, the terminal 102 performs the layer 3 measurement on the designated resource position, in response to the terminal 102 not supporting performing the layer 1 measurement and the layer 3 measurement simultaneously.

In the example of the present disclosure, the terminal receives the second indication information transmitted by the network device. The second indication information indicates the designated resource position available for performing the layer 1 measurement among the resource position where the layer 3 measurement is performed. The terminal may determine that the layer 1 measurement and the layer 3 measurement may be performed simultaneously on the designated resource position.

However, the terminal needs to determine whether the terminal supports performing the layer 1 measurement and the layer 3 measurement simultaneously. The layer 3 measurement may be performed on the designated resource position without the layer 1 measurement being performed, in a case that the terminal does not support performing the layer 1 measurement and the layer 3 measurement simultaneously.

It is to be noted that in the example of the present disclosure, S61 to S62 may be implemented independently, or may be implemented together with any other step in the example of the present disclosure, for example, implemented together with at least one of S31 or S51 to S52 in the example of the present disclosure, which is not limited in the example of the present disclosure.

By implementing the example of the present disclosure, the network device transmits the second indication information to the terminal. The second indication information is configured to indicate the designated resource position available for performing the layer 1 measurement among the resource position where the layer 3 measurement is performed. The terminal performs the layer 1 measurement and the layer 3 measurement simultaneously on the designated resource position, in response to the terminal supporting performing the layer 1 measurement and the layer 3 measurement simultaneously. Thus, in a case that the terminal supports performing the layer 1 measurement and the layer 3 measurement simultaneously, the terminal may perform the layer 1 measurement and the layer 3 measurement simultaneously on the designated resource position indicated by the network device.

In the example provided by the present disclosure, the method provided in the example of the present disclosure is introduced from the perspective of interaction between the terminal and the network device.

With reference to FIG. 7, a schematic structural diagram of a communication device 1 according to an example of the present disclosure is provided. The communication device 1 shown in FIG. 7 may include a transceiving module 11 and a processing module 12. The transceiving module may include at least one of a transmitting module (not shown) or a receiving module (not shown). The transmitting module is configured to implement a transmitting function. The receiving module is configured to implement a receiving function. The transceiving module may implement at least one of the transmitting function or the receiving function.

The communication device 1 may be a terminal, a communication device in the terminal, or a communication device that can be used in conjunction with the terminal. Alternatively, the communication device 1 may be a network device, a communication device in a network device, or a communication device that can be used in conjunction with the network device.

The communication device 1 is a network device, the communication device includes a transceiving module 11.

The transceiving module 11 is configured to receive capability information reported by a terminal. The capability information is configured to indicate whether the terminal supports performing layer 1 measurement and layer 3 measurement simultaneously.

In some examples, the transceiving module 11 is further configured to transmit first indication information to the terminal in response to the capability information being configured to indicate that the terminal supports performing the layer 1 measurement and the layer 3 measurement simultaneously. The first indication information is configured to indicate that the terminal performs the layer 1 measurement on a resource position where the layer 3 measurement is performed.

In some examples, the transceiving module 11 is further configured to transmit second indication information to the terminal. The second indication information is configured to indicate a designated resource position available for performing the layer 1 measurement among resource positions for performing the layer 3 measurement.

In some examples, the transceiving module 11 is further configured to transmit a measurement configuration to the terminal. The measurement configuration is configured to indicate the resource position for the terminal to perform the layer 3 measurement.

In some examples, the capability information is one bit. The one bit being a first value indicates that the terminal supports performing the layer 1 measurement and the layer 3 measurement simultaneously. The one bit being a second value indicates that the terminal does not support performing the layer 1 measurement and the layer 3 measurement simultaneously.

The communication device 1 is a terminal, the communication device includes a transceiving module 11 and a processing module 12.

The transceiving module 11 is configured to report capability information to a network device. The capability information is configured to indicate whether the terminal supports performing layer 1 measurement and layer 3 measurement simultaneously.

In some examples, the transceiving module 11 is further configured to receive first indication information transmitted by the network device. The first indication information is transmitted by the network device in a case that the capability information is configured to indicate that the terminal supports performing the layer 1 measurement and the layer 3 measurement simultaneously. The first indication information is configured to indicate that the terminal performs the layer 1 measurement on a resource position where the layer 3 measurement is performed.

The processing module 12 is configured to perform, according to the first indication information, the layer 1 measurement simultaneously on the resource position where the layer 3 measurement is performed.

In some examples, the transceiving module 11 is further configured to receive second indication information transmitted by the network device. The second indication information is configured to indicate a designated resource position available for performing the layer 1 measurement among resource positions where the layer 3 measurement is performed.

In some examples, the processing module 12 is configured to perform the layer 1 measurement and the layer 3 measurement simultaneously on the designated resource position, in response to the terminal supporting performing the layer 1 measurement and the layer 3 measurement simultaneously.

In some examples, the processing module 12 is configured to perform the layer 3 measurement on the designated resource position, in response to the terminal not supporting performing the layer 1 measurement and the layer 3 measurement simultaneously.

In some examples, the transceiving module 11 is further configured to receive a measurement configuration transmitted by the network device. The measurement configuration is configured to indicate the resource position for the terminal to perform the layer 3 measurement.

In some examples, the capability information is one bit. The one bit being a first value indicates that the terminal supports performing the layer 1 measurement and the layer 3 measurement simultaneously. The one bit being a second value indicates that the terminal does not support performing the layer 1 measurement and the layer 3 measurement simultaneously.

With respect to the communication device 1 in the example, particular ways in which the various modules perform operations have been described in detail in the examples relating to the method, and will not be described in detail.

The communication device 1 provided in the example of the present disclosure achieves the same or similar beneficial effects as the method for reporting a terminal capability provided in some of the examples, and the beneficial effects are not repeated.

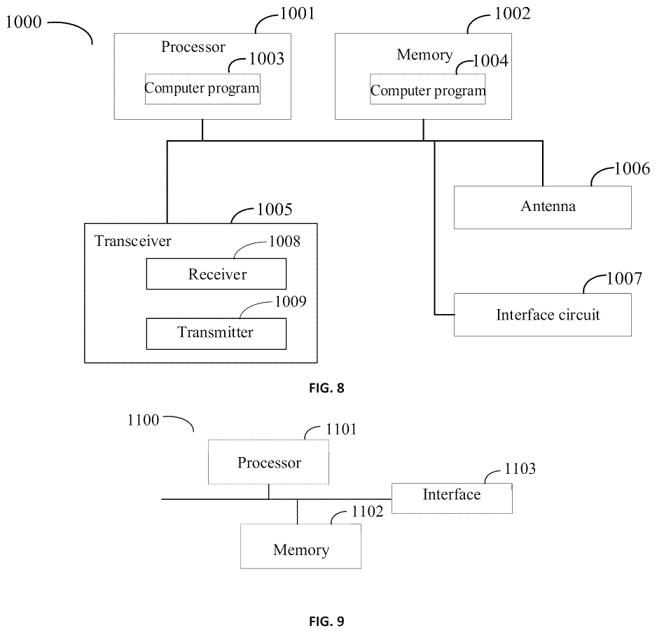

With reference to FIG. 8, FIG. 8 is a schematic structural diagram of another communication device 1000 according to an example of the present disclosure. The communication device 1000 may be a network device, may be a terminal, may be a chip, a chip system, or a processor that supports a network device to implement the method, or may be a chip, a chip system, or a processor that supports a terminal to implement the method. The communication device 1000 may be configured to implement the methods described in the method examples, and reference may be made to description in the method examples for specific details.

The communication device 1000 may include one or more processors 1001. The processor 1001 may be a general purpose processor or a special purpose processor, etc., such as a baseband processor or a central processor. The baseband processor may be configured to process a communication protocol and communication data. The central processor may be configured to control a communication device (for example, a network device, a baseband chip, a terminal, a terminal chip, a DU or a CU), execute a computer program, and process data of the computer program.

In some examples, the communication device 1000 may further include one or more memories 1002 that may store a computer program 1004. The memory 1002 executes the computer program 1004 to cause the communication device 1000 to perform the method described in the method examples. In some examples, the memory 1002 may also store data. The communication device 1000 and the memory 1002 may be arranged separately or may be integrated together.

In some examples, the communication device 1000 may further include a transceiver 1005 and an antenna 1006. The transceiver 1005 may be referred to as a transceiving unit, a transceiving machine, a transceiving circuit, etc., and is configured to implement a transceiving function. The transceiver 1005 may include a receiver 1008 and a transmitter 1009. The receiver 1008 may be referred to as a receiving machine or a receiving circuit, etc., for implementing a reception function. The transmitter 1009 may be referred to as a transmitting machine, a transmitting circuit, etc., for implementing a transmission function.

In some examples, the communication device 1000 may further include one or more interface circuits 1007. The interface circuit 1007 is configured to receive a code instruction and transmit the code instruction to the processor 1001. The processor 1001 runs the code instruction to cause the communication device 1000 to perform the method described in the method examples.

In a case where the communication device 1000 is a network device, the transceiver 1005 is configured to perform S31 in FIG. 3, S41 in FIG. 4. S51 in FIG. 5, and S61 in FIG. 6.

In a case where the communication device 1000 is a terminal, the transceiver 1005 is configured to perform S31 in FIG. 3, S41 in FIG. 4, S51 in FIG. 5, and S61 in FIG. 6, and the processor 1001 for configured to perform S42 in FIG. 4, S52 in FIG. 5, and S62 in FIG. 6.

In an implementation, the processor 1001 may include a transceiver for implementing a reception function and a transmission function. For example, the transceiver may be a transceiving circuit, an interface, or an interface circuit. The transceiving circuit, interface, or interface circuit for implementing the reception function and the transmission function may be separated or integrated. The transceiving circuit, interface or interface circuit may be configured to read and write a code/data, and alternatively, the transceiving circuit, interface or interface circuit may be configured to transmit or transfer a signal.

In one implementation, the processor 1001 may store a computer program 1003. The computer program 1003 runs on the processor 1001 and causes the communication device 1000 to perform the method described in the method examples above. The computer program 1003 may be embedded in the processor 1001. In this case, the processor 1001 may be implemented by hardware.

In an implementation, the communication device 1000 may include a circuit that may implement the functions of transmission, reception or communication in the foregoing method examples. The processor and transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may also be fabricated by using various IC process technologies, such as a complementary metal oxide semiconductor (CMOS), an n-metal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device described in the examples may be a terminal or a network device. The scope of the communication device described in the present disclosure is not limited to this, and a structure of the communication device may not be limited by FIG. 8. The communication device may be a stand-alone device or may be part of a large device. For example, the communication device may be:
(1) an independent integrated circuit (IC), a chip, a chip system or a subsystem;
(2) a set of one or more ICs, in some examples, this set of ICs including a memory component for storing data and a computer program;
(3) an ASIC, such as a modem;
(4) a module that can be embedded in other devices;
(5) a receiver machine, a terminal, an intelligent terminal, a cellular phone, a radio device, a handset, a mobile unit, a vehicle-mounted device, a network device, a cloud device, an artificial intelligence device, etc.; and
(6) others, etc.

Reference may be made to FIG. 9 which is a structural diagram of a chip according to the examples of the present disclosure for a case where the communication device may be a chip or a chip system.

The chip 1100 includes a processor 1101 and an interface 1103. One or more processors 1101 may be provided. A plurality of interfaces 1103 may be provided.

For the case that the chip is configured to implement the function of the terminal in the example of the present disclosure:
the interface 1103 is configured to receive code instructions and transmit the code instructions to the processor; and
the processor 1101 is configured to run the code instructions, so as to perform the method for reporting a terminal capability according to some of the examples.

For the case that the chip is configured to implement the function of the network device in the example of the present disclosure:
the interface 1103 is configured to receive code instructions and transmit the code instructions to the processor; and
the processor 1101 is configured to run the code instructions, so as to perform the method for reporting a terminal capability according to some of the examples.

In some examples, the chip 1100 further includes a memory 1102. The memory 1102 is configured to store a necessary computer program and data.

Those skilled in the art will further appreciate that the various illustrative logical blocks and steps set forth in the examples of the present disclosure may be implemented by electronic hardware, computer software, or combinations of both. Whether such functions are implemented by hardware or software depends on a particular application and overall system design requirements. Those skilled in the art may use various methods to implement the functions for each particular application, but such implementation should not be understood to fall beyond the scope of protection of the examples of the present disclosure.

The examples of the present disclosure further provide a system for reporting a terminal capability. The system includes the communication device serving as a terminal and the communication device serving as a network device in the example of FIG. 7. Alternatively, the system includes the communication device serving as a terminal and the communication device serving as a network device in the example of FIG. 8.

The present disclosure further provides a non-transitory computer-readable storage medium. The non-transitory computer-readable storage medium stores an instruction. The instruction implements the functions of any one of the method examples when executed by a computer.

The present disclosure further provides a computer program product. The computer program product, when executed by a computer, implements the functions of the method examples.

In the technical solution, the capability information reported by the terminal is received. The capability information is configured to indicate whether the terminal supports performing the layer 1 measurement and the layer 3 measurement simultaneously. Thus, the terminal may be supported to report, to the network device, the capability information for indicating whether the terminal supports performing the layer 1 measurement and the layer 3 measurement simultaneously.

The examples described can be implemented in whole or in part by software, hardware, firmware, or their any combinations. When implemented through the software, all or some of the modules may be implemented in the form of computer program products. The computer program product includes one or more computer programs. When loaded and executed on a computer, the computer program generates in whole or in part the flows or functions described in accordance with the examples of the present disclosure. The computer may be a general-purpose computer, a special-purpose computer, a computer network, or another programmable device. The computer program may be stored in a non-transitory computer-readable storage medium or transmitted by one non-transitory computer-readable storage medium to another non-transitory computer-readable storage medium. For example, the computer program can be transmitted by one website, computer, server, or data center to another website, computer, server, or data center through a wired means (for example, a coaxial cable, an optical fiber, and a digital subscriber line (DSL)) or through a radio means (for example, infrared, radio waves, and microwaves). The non-transitory computer-readable storage medium may be any available medium that can be accessed by a computer or a data storage device including one or more available media integrated server, a data center, etc. The available medium may be a magnetic medium (for example, a floppy disk, a hard disk, and a magnetic tape), an optical medium (for example, a digital video disk (DVD)), or a semiconductor medium (for example, a solid state disk (SSD)), etc.

Those skilled in the art may understand that the first, second and other numerical numbers referred to in the present disclosure are merely for distinction for convenience of description, and are not intended to limit the scope of the examples of the present disclosure, and also represent the sequence.

At least one in the present disclosure may also be described as one or more, and plurality may be two, three, four, or more, which are not limited in the present disclosure. In the examples of the present disclosure, for a type of technical feature, technical features in such a type of technical feature are distinguished by “first”, “second”, “third”, “A”, “B”, “C” and “D”, and the technical features described by the “first”, “second”, “third”, “A”, “B”, “C” and “D” have no order of sequence or order of magnitude.

Correspondence relations shown in tables of the present disclosure may be configured or predefined. Values of information in each table are only instances, and may be configured as other values, which are not limited in the present disclosure. When a correspondence relation between the information and each parameter is configured, it is not necessarily required to configure all the correspondence relations indicated in each table. For example, in the tables of the present disclosure, the correspondence relations shown in some rows may not be configured. For another example, appropriate modification adjustments, such as splitting and merging, can be made based on the table. Names of the parameters shown in the titles of the tables may also be other names that can be understood by the communication device, and values or expression modes of the parameters may also be other values or expression modes that can be understood by the communication device. When the tables are implemented, other data structures may also be used, such as an array, a queue, a container, a stack, a linear table, a pointer, a linked list, a tree, a graph, a structure, a class, a heap, and a hash table.

Predefinition in the present disclosure may be understood as defining, predefining, storing, pre-storing, pre-negotiating, pre-configuring, curing, or pre-firing.

As used herein, the term “processor” may refer to one processor that performs the defined functions or a plurality of processors that collectively perform defined functions, such that the execution of the individual defined functions may be divided amongst such processors.

Those of ordinary skill in the art may appreciate that the units and algorithm steps of the instances described in conjunction with the examples disclosed may be implemented in electronic hardware, or a combination of computer software and electronic hardware. Whether these functions are performed with hardware or software depends on the specific application and design constraints of the technical solution. Those skilled can implement the described functions with different methods for each particular application, but such implementation should not be considered to fall beyond the scope of the present disclosure.

Those skilled in the art will clearly appreciate that, for convenience and conciseness of description, reference can be made to corresponding processes in the foregoing method examples for specific working processes of the systems, devices and units, which are not repeated.

What are described are merely particular implementations of the present disclosure, and are not intended to limit the scope of protection of the present disclosure, and any changes or substitutions that can readily occur to those skilled in the art within the scope of technology disclosed in the present disclosure should fall within the scope of protection of the present disclosure. Thus the scope of protection of the present disclosure should be subject to the scope of protection of the claims.

1. A method for reporting a terminal capability, performed by a network device, the method comprising:
receiving capability information reported by a terminal, wherein the capability information is configured to indicate whether the terminal supports performing layer 1 measurement and layer 3 measurement simultaneously.

2. The method according to claim 1, wherein the method further comprises:
transmitting first indication information to the terminal in response to the capability information being configured to indicate that the terminal supports performing the layer 1 measurement and the layer 3 measurement simultaneously, wherein the first indication information is configured to indicate that the terminal performs the layer 1 measurement on a resource position where the layer 3 measurement is performed.

3. The method according to claim 1, wherein the method further comprises:
transmitting second indication information to the terminal, wherein the second indication information is configured to indicate a designated resource position available for performing the layer 1 measurement among resource positions for performing the layer 3 measurement.

4. The method according to claim 2, wherein the method further comprises:
transmitting a measurement configuration to the terminal, wherein the measurement configuration is configured to indicate the resource position for the terminal to perform the layer 3 measurement.

5. The method according to claim 1, wherein the capability information is one bit; the one bit being a first value indicates that the terminal supports performing the layer 1 measurement and the layer 3 measurement simultaneously; the one bit being a second value indicates that the terminal does not support performing the layer 1 measurement and the layer 3 measurement simultaneously.

6. A method for reporting a terminal capability, performed by a terminal, the method comprising:
reporting capability information to a network device, wherein the capability information is configured to indicate whether the terminal supports performing layer 1 measurement and layer 3 measurement simultaneously.

7. The method according to claim 6, wherein the method further comprises:
receiving first indication information transmitted by the network device, wherein the first indication information is transmitted by the network device in a case that the capability information is configured to indicate that the terminal supports performing the layer 1 measurement and the layer 3 measurement simultaneously, and the first indication information is configured to indicate that the terminal performs the layer 1 measurement on a resource position where the layer 3 measurement is performed; and
performing, according to the first indication information, the layer 1 measurement simultaneously on the resource position where the layer 3 measurement is performed.

8. The method according to claim 6, wherein the method further comprises:
receiving second indication information transmitted by the network device, wherein the second indication information is configured to indicate a designated resource position available for performing the layer 1 measurement among resource positions where the layer 3 measurement is performed.

9. The method according to claim 8, wherein the method further comprises:
performing the layer 1 measurement and the layer 3 measurement simultaneously on the designated resource position, in response to the terminal supporting performing the layer 1 measurement and the layer 3 measurement simultaneously.

10. The method according to claim 8, wherein the method further comprises:
performing the layer 3 measurement on the designated resource position, in response to the terminal not supporting performing the layer 1 measurement and the layer 3 measurement simultaneously.

11. The method according to claim 7, wherein the method further comprises:
receiving a measurement configuration transmitted by the network device, wherein the measurement configuration is configured to indicate the resource position for the terminal to perform the layer 3 measurement.

12. The method according to claim 6, wherein the capability information is one bit; the one bit being a first value indicates that the terminal supports performing the layer 1 measurement and the layer 3 measurement simultaneously; and the one bit being a second value indicates that the terminal does not support performing the layer 1 measurement and the layer 3 measurement simultaneously.

13-14. (canceled)

15. A network device, comprising one or more processors and a memory, wherein the memory stores a computer program, and the one or more processors, when executing the computer program stored in the memory, cause the network device to:
receive capability information reported by a terminal, wherein the capability information is configured to indicate whether the terminal supports performing layer 1 measurement and layer 3 measurement simultaneously.

16. A network device, comprising one or more processors and an interface circuit, wherein
the interface circuit is configured to receive code instructions and transmit the code instructions to the one or more processors; and
the one or more processors are collectively configured to run the code instructions to perform the method according to claim 1.

17. A non-transitory computer-readable storage medium configured to stores instructions, wherein the instructions, when executed by one or more processors, cause the one or more processors to perform the method according to claim 1.

18. The network device according to claim 15, wherein the network device is further configured to:
transmit first indication information to the terminal in response to the capability information being configured to indicate that the terminal supports performing the layer 1 measurement and the layer 3 measurement simultaneously, wherein the first indication information is configured to indicate that the terminal performs the layer 1 measurement on a resource position where the layer 3 measurement is performed.

19. The network device according to claim 15, wherein the network device is further configured to:
transmit second indication information to the terminal, wherein the second indication information is configured to indicate a designated resource position available for performing the layer 1 measurement among resource positions for performing the layer 3 measurement.

20. A terminal, comprising one or more processors and a memory, wherein the memory stores a computer program, and the one or more processors, when executing the computer program stored in the memory, cause the terminal to perform the method according to claim 6.

21. A terminal, comprising one or more processors and an interface circuit, wherein
the interface circuit is configured to receive code instructions and transmit the code instructions to the one or more processors; and
the one or more processors are collectively configured to run the code instructions to perform the method according claim 6.

22. A non-transitory computer-readable storage medium, configured to store instructions, wherein the instructions, when executed, cause one or more processors to perform the method according to claim 6.
